(19) United States
(12) Patent Application Publication
(10) Pub. No.: US 2016/0118815 A1
(43) Pub. Date: Apr. 28, 2016

(54) ELECTRONIC APPARATUS

(71) Applicant: Kabushiki Kaisha Toshiba, Tokyo (JP)

(72) Inventors: Akio KANOU, Tokyo (JP); Tomonori TSUTSUI, Tokyo (JP)

(73) Assignee: Kabushiki Kaisha Toshiba, Tokyo (JP)

(21) Appl. No.: 14/808,629

(22) Filed: Jul. 24, 2015

Related U.S. Application Data
(60) Provisional application No. 62/067,827, filed on Oct. 23, 2014.

(51) Int. Cl. H02J 7/00

(52) U.S. Cl. CPC H02J 7/007; H02J 7/0047

(57) ABSTRACT

On embodiment relates to an electronic apparatus, including a component configured to receive a power supply as a load; first and second battery drivers configured to manage charging and discharging of first and second batteries and cause them to perform the power supply to the load, respectively; and a controller configured to, upon detection of elapse of a predetermined period from when the first battery is brought into a fully-charged condition, prohibit the power supply to the load from the second battery or a power supply to the load from an external power source, and permit the power supply to the load from the first battery, until a remaining amount of the first battery falls below a predetermined value.

### CROSS-REFERENCE TO RELATED APPLICATION(S)

This application claims priority from U.S. Provisional Patent Application No. 62/067,827 filed on Oct. 23, 2014, the entire contents of which are incorporated herein by reference.

### TECHNICAL FIELD

An embodiment of the invention relates to an electronic apparatus which is powered by a battery or an external power source.

### BACKGROUND ART

Among electronic apparatuses on which plural batteries are mounted, such as a two-in-one notebook PC, there are apparatuses in which one of the batteries to be preferentially used is set. In the case where batteries A and B are mounted on an electronic apparatus, and the battery A is set to be preferentially used, for example, the battery A is first used, and when the remaining capacity of the battery A is consumed, the battery to be used is automatically switched to the battery B.

In this case, depending on the use environment of the user, charging and discharging may be repeated almost only in the battery A, and the battery B may remain to be fully charged. That is, the battery B may be brought into a “left-fully-charged condition”. The life of the battery B can be prolonged by making an improvement in this regard.

Usually, to avoid the left-fully-charged condition, ECO charging (smart charging) may be set. ECO charging is a method in which the left-fully-charged condition is avoided by suppressing the charging of a battery to, for example, 80% of the full charge capacity, thereby prolonging the life of the battery. Even in the case where setting of ECO charging is applied as it is to the above-described configuration, when the battery B is at full charge at the timing when ECO charging is set, however, the battery A to be preferentially used is set is continued to be used. Therefore, charging and discharging may be repeated only in the battery A are repeated, and the left-fully-charged condition of the battery B still may not be avoided.

### BRIEF DESCRIPTION OF DRAWINGS

FIG. 1 is a perspective view showing the appearance of an electronic apparatus of an embodiment.

FIG. 2 is a view showing a first style of using the electronic apparatus of the embodiment.

FIG. 3 is a view showing a second style of using the electronic apparatus of the embodiment.

FIG. 4 is a diagram showing the system configuration of the electronic apparatus of the embodiment.

FIG. 5 is a schematic diagram showing main portions of the embodiment.

FIG. 6 is a view illustrating examples of setting of preferential use of a battery in the embodiment, and actual usable batteries.

FIG. 7 is a flowchart illustrating the operation of the embodiment.

FIGS. 8A and 8B are views illustrating an IIC (I2C) interface used in the embodiment.

FIG. 9 is a view showing an example of a pop-up display on an LCD 11A according to the embodiment.

### DESCRIPTION OF EMBODIMENTS

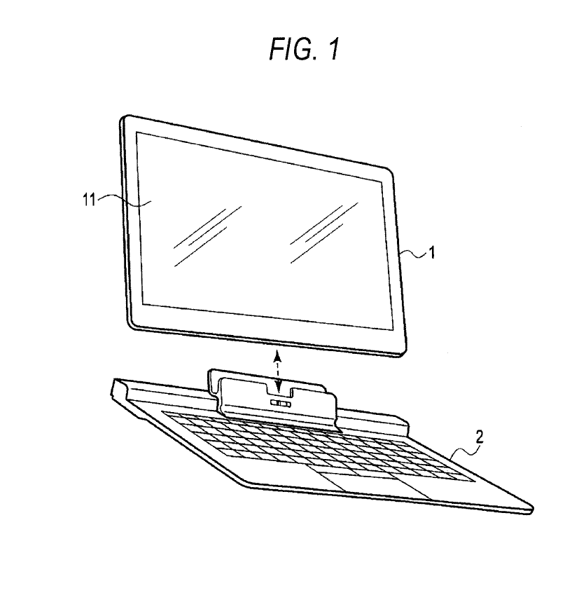

Hereinafter, an embodiment will be described with reference to FIGS. 1 to 9.

FIG. 1 is a perspective view showing the appearance of an electronic apparatus of an embodiment. The electronic apparatus is a portable electronic apparatus in which, for example, a handwriting input with a pen or a finger is enabled. Hereinafter, the “electronic apparatus” may refer to a tablet computer 1 or a system including the tablet computer 1 and a keyboard dock 2.

As shown in FIG. 1, the tablet computer 1, as a main unit, includes a touch screen display 11. The touch screen display 11 is attached so as to overlap the upper surface of the tablet computer 1. A flat panel display, and sensors which are configured so as to detect the position of a pen or a finger on the screen of the flat panel display are incorporated in the touch screen display 1 1. For example, the flat panel display is a liquid crystal display device (LCD) or the like. For example, the sensors are an electrostatic capacitance type touch panel, an electromagnetic induction type digitizer, and the like. Here, it is assumed that both of two kinds of sensors or a digitizer and a touch panel are incorporated in the touch screen display 11.

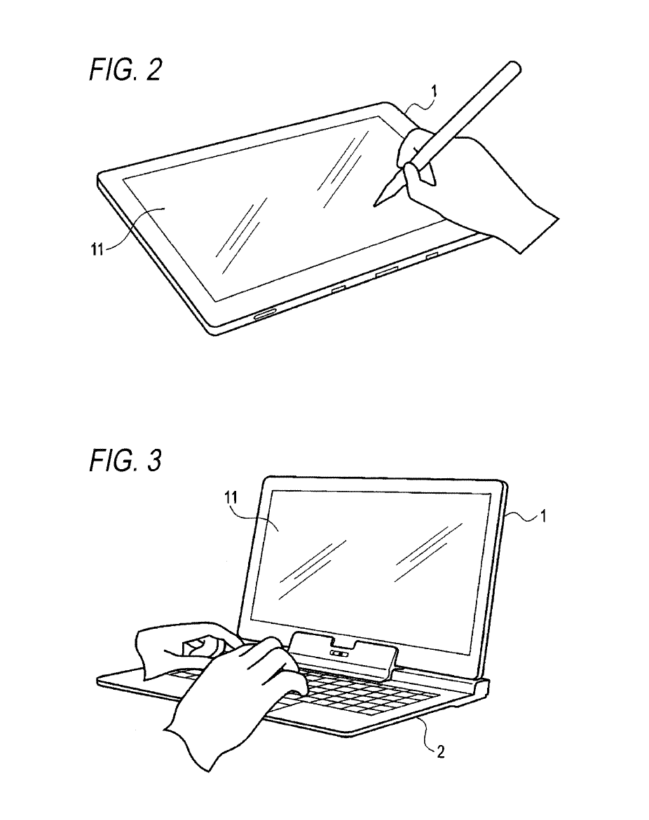

As shown in FIG. 1, the tablet computer 1 is connectable with the keyboard dock 2, as an expansion unit. The keyboard dock 2 includes a keyboard. Namely, the tablet computer 1 can be used in either one of two styles, i.e., a state where only the tablet computer 1 itself is used (the keyboard dock 2 is not connected thereto) as shown in FIG. 2, and that where the keyboard dock 2 is connected thereto as shown in FIG. 3. The state shown in FIG. 2 is called a tablet mode or the like, and that shown in FIG. 3 is called a clamshell mode or the like.

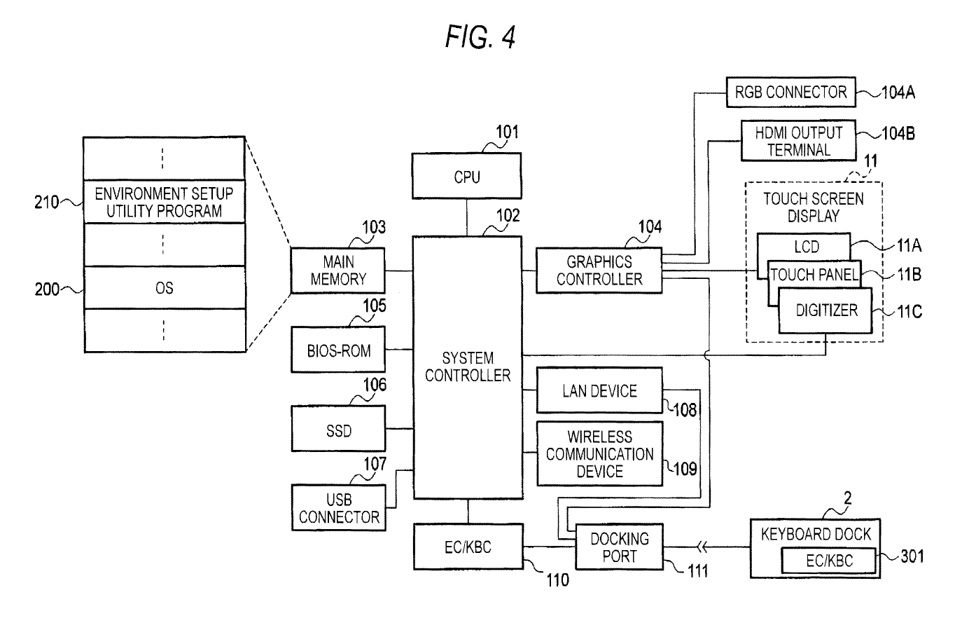

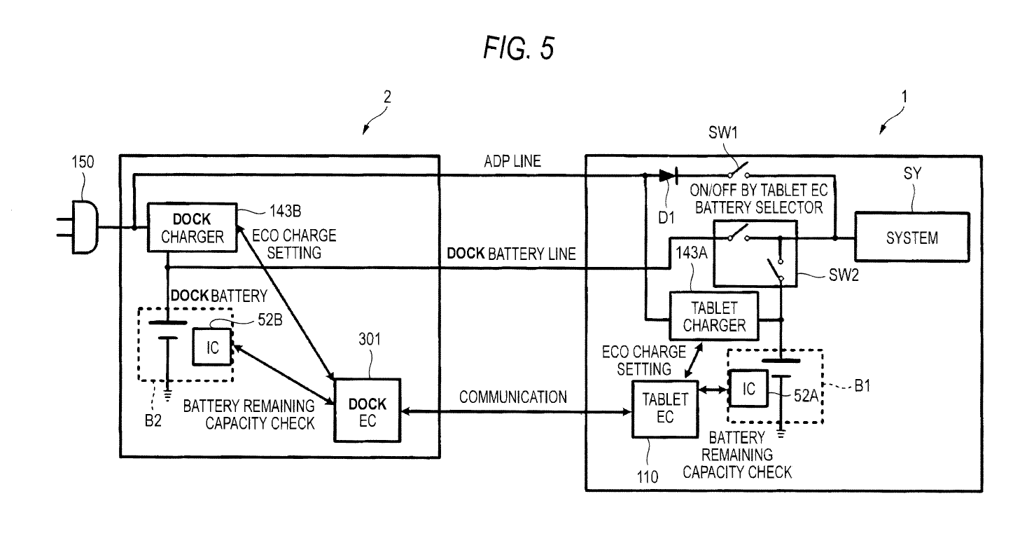

FIG. 4 is a diagram showing the system configuration of the tablet computer 1 as the main unit. The power supply control including the tablet computer 1 as the main unit and the keyboard dock 2 as the expansion unit will be described with reference to FIG. 5.

As shown in FIG. 4, the tablet computer 1 includes a CPU 101, a system controller 102, a main memory 103, a graphics controller 104, an RGB connector 104A, an HDMI (registered trademark) (High-definition multimedia interface) output terminal 104B, a BIOS-ROM 105, an SSD (Solid state drive) 106, a USB connector 107, a LAN device 108, a wireless communication device 109, an EC/KBC (Embedded controller/Keyboard controller) 110, a docking port 111, and the like.

The CPU 101 is a processor which controls the operations of various modules of the tablet computer 1. The CPU 101 executes various kinds of programs which are loaded from the SSD 106 onto the main memory 103. The programs which are to be executed by the CPU 101 include an operating system (OS) 200, an environment setup utility program 210 which operates under control of the OS 200, and which will be described later, and the like.

Moreover, the CPU 101 executes also a basic input output system (BIOS, hereinafter referred to as the BIOS 250) stored in the BIOS-ROM 105. The BIOS 250 is a program for hardware control.

The system controller 102 is a device for connecting between the local bus of the CPU 101 and various components. The system controller 102 incorporates a memory controller for controlling an access to the main memory 103, and a serial ATA controller for controlling an access to the SSD 106. The system controller 102 has also a function of communicating with the graphics controller 104 and the EC/KBC 110 via a serial bus or the like.

The graphics controller 104 is a display controller which controls the LCD 11A employed as a display monitor for the tablet computer 1. The graphics controller 104 generates a display signal (LVDS signal) which is to be supplied to the LCD 11A, from display data output from various programs. The graphics controller 104 can generate also an analog RGB signal and an HDMI video signal from the display data. The analog RGB signal is supplied to an external display via the RGB connector 104A, and the HDMI video signal is supplied to the external display via the HDMI output terminal 104B. The HDMI output terminal 104B is a terminal which enables an HDMI video signal (non-compressed digital video signal) and a digital audio signal to be transmitted through one cable. The graphics controller 104 can transmit the analog RGB signal and the HDMI video signal, also to the keyboard dock 2 via the docking port 111. The docking port 111 is a port for electrically connecting the tablet computer 1 with the keyboard dock 2.

The LCD 11A displays a screen image based on the display signal supplied from the graphics controller 104. A touch panel 11B which is a first sensor for sensing the position of a finger on the screen is placed in the upper layer of the LCD 11A. Moreover, a digitizer 11C which is a second sensor for sensing the position of a pen on the screen is placed in the lower layer of the LCD 11A. The touch panel 11B is an electrostatic capacitance type pointing device. The contact position on the screen where the finger is in contact with the screen, the motion of the contact position, and the like are detected by the touch panel 11B. By contrast, the digitizer 11C is an electromagnetic induction type pointing device. The contact position on the screen where a pen is in contact with the screen, the motion of the contact position, and the like are detected by the digitizer 11C.

The USB connector 107 is a connector for connecting a USB device such as a USB memory. The LAN device 108 is a device which executes wired communication according to, for example, the IEEE 802.3 standard. A connection to the LAN of the tablet computer 1 is performed by connecting a LAN cable to a LAN connector disposed on the side of the keyboard dock 2 which is to be connected to the docking port 111. The wireless communication device 109 is a device which executes wireless communication according to, for example, the IEEE 802.11g standard.

The EC/KBC 110 is a power management controller which executes power management of the tablet computer 1, and has a function of powering ON and OFF the tablet computer 1 depending on an operation by the user on a power button.

An EC/KBC 301 is a power management controller which executes power management of the keyboard dock 2. The EC/KBC 301 incorporates a keyboard controller which controls the keyboard mounted on the keyboard dock 2. The EC/KBC 301 is configured so as to control a backlight of the keyboard dock 2 and an LED for displaying the power condition.

Now, it is assumed that the tablet computer 1 is powered ON in the state where the keyboard dock 2 is connected to the docking port 111. When the tablet computer 1 is powered ON, the BIOS 250 executes the POST (Power on self test). In the POST, the BIOS 250 diagnoses various components of the tablet computer 1, and initializes the settings of the components. In the POST, the BIOS 250 recognizes that the keyboard dock 2 is connected, and acquires a Dock-ID from the keyboard dock 2. Next, the tablet computer 1 activates the OS 200. In the tablet computer 1, when the OS 200 is activated, the environment setup utility program 210 is activated under control of the OS 200.

When activated, the environment setup utility program 210 first acquires the Dock-ID of the keyboard dock 2 from the BIOS 250.

FIG. 5 is a functional diagram showing main portions of the embodiment of the electronic apparatus. In the electronic apparatus shown in FIG. 5 as a system, plural batteries are mounted on the tablet apparatus and the dock, respectively.

In the tablet computer 1 which is the tablet apparatus, a constant-voltage source is provided through an ADP line by an AC adaptor 150 that uses a commercial AC power supply, and that is connected as an external power source. The AC adaptor 150 is configured by components such as a transformer, a rectifying section using a diode bridge, and a smoothing capacitor. The constant-voltage source can be supplied to a tablet charger 143A via a backflow preventing diode D1 and a switch SW1, and to a system SY (electric/electronic functional sections in which the components of FIG. 5 are excluded from the tablet computer 1).

The tablet EC (EC/KBC) 110 is configured so as to perform a charge/discharge control communication with a battery B1 and the tablet charger 143A. When the battery B1 is charged, for example, the firmware of the tablet EC 110 determines the start/stop (permission/prohibition) of charging of the battery 131 while determining the state of a (Gas Gauge) IC (52A) in the battery B1. The IC (52A) is an IC which is configured so as to provide the host (above-described firmware) with information related to various states of battery cells in the battery B1.

Also in the keyboard dock 2 which is a dock, similarly, the constant-voltage source relates to the supply to a dock charger 143B.

The dock EC (EC/KBC) 301 is configured so as to perform a charge/discharge control communication with a battery B2 and the dock charger 143B. When the battery B2 is charged, for example, the firmware of the dock EC 301 determines the start/stop (permission/prohibition) of charging of the battery B2 while determining the state of a (Gas Gauge) IC (52B) in the battery B2. The IC (52B) is an IC which is configured so as to provide the host (above-described firmware) with information related to various states of battery cells in the battery B2.

The EC/KBC 301 controls the lighting of a keyboard (not shown) and the like. The keyboard includes a backlight (not shown), and is configured so that the lighting of the backlight is controlled by the EC/KBC 301.

A switch SW2 is used for enabling either one of the battery B1 and the battery B2 to supply electric power to the system SY, by, for example, the environment setup utility program 210. The intercommunication between the tablet EC 110 and the dock EC 301 is performed via an IIC interface which will be described later.

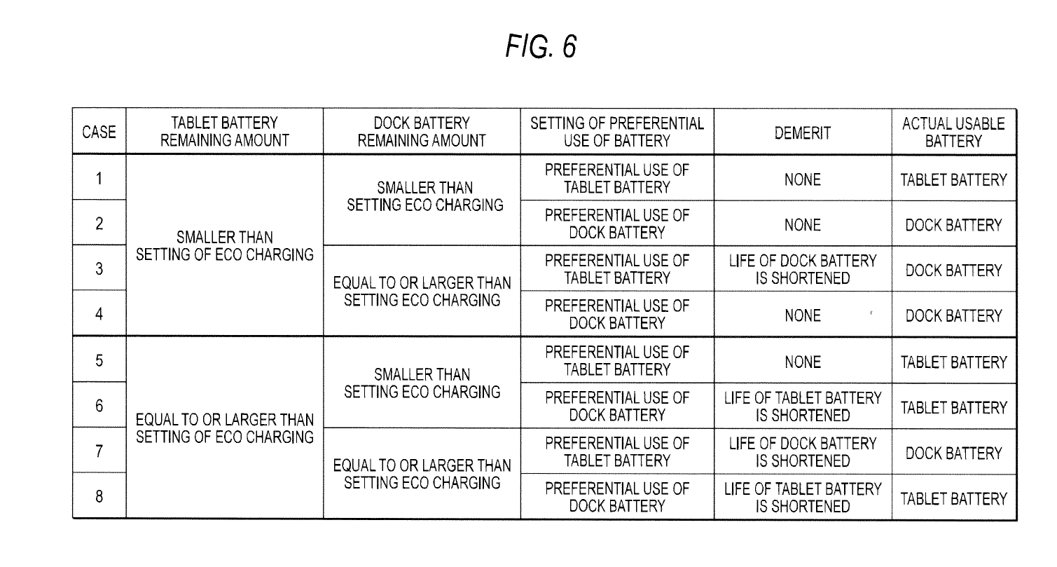

FIG. 6 is a view illustrating the outline of the operation of the embodiment. With respect to each of the tablet battery remaining amount (remaining capacity), the dock battery remaining amount (remaining capacity), and the setting of preferential use of a battery, two cases exist, and therefore there are eight cases in total. Among them, Case 7 and Case 8 are noteworthy.

In the cases, both the remaining amounts of the tablet and dock batteries are equal to or larger than the setting of ECO charging (smart charging). In the cases, when the setting of preferential use of a battery is the preferential use of the tablet battery, the life of the dock battery is shortened, and when the setting is the preferential use of the dock battery, the life of the tablet battery is shortened.

The following measures centering on the cases will be taken.

(1) The controller (EC) in the electronic apparatus acquires the remaining amounts of the table/dock batteries, and a battery in which the remaining amount is larger than the setting of ECO charging (for example: 80% of the full charge capacity) is used. This prevents the non-preferential use battery from being bought into the left-fully-charged condition to shorten the life of the battery.

(2) In the case of (1), when there are plural batteries in which the remaining amount is larger than the setting of ECO charging, “non-preferential battery” having a higher possibility of being brought into the left-fully-charged condition is preferentially used.

(3) In the case of (1) or (2) above, when “use of non-preferential battery” is to be performed, the use is automatically switched to the use of a preferential battery after the non-preferential battery is used until the threshold of the setting of ECO charging is reached.

An example will be considered in which the setting of ECO charging is 80%, the remaining capacity of the tablet battery is 100%, the remaining capacity of the dock battery is 70%, and when the preferential use of the dock battery is set, the tablet battery is first used until 80% of capacity is reached, and thereafter the use is switched to the use of the dock battery.

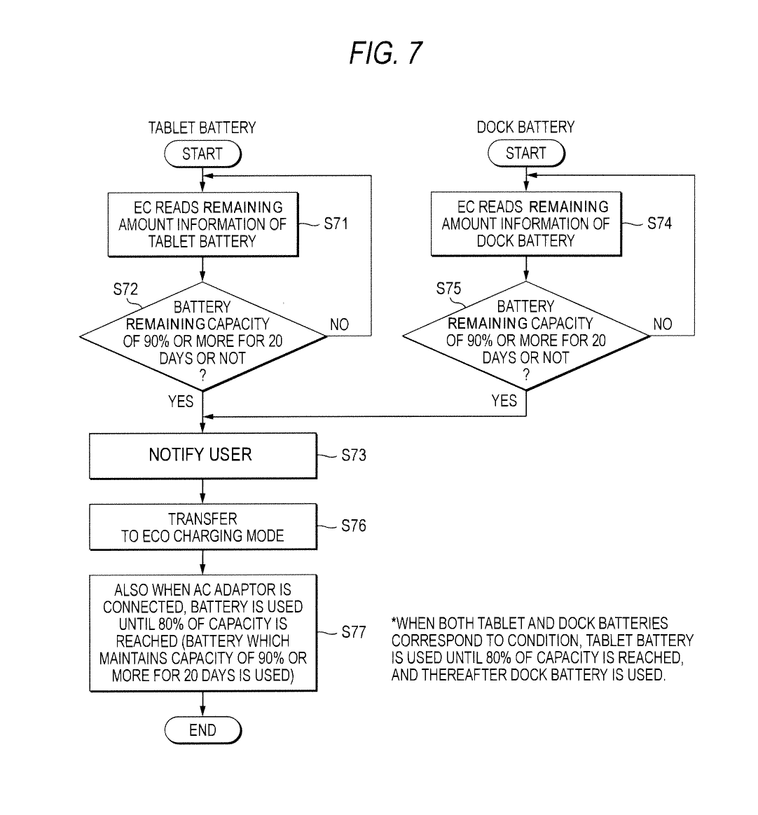

FIG. 7 is a flowchart illustrating the operation of the embodiment.

Step S71: The tablet EC 110 reads remaining amount information of the battery B1.
Step S72: The tablet EC 110 determines whether the battery B1 maintains 90% or more of capacity for 20 days or not. If the determination is NO, the process proceeds to step S71, and if YES, the process proceeds to step S73.
Step S74: The dock EC 301 reads remaining amount information of the battery B2.
Step S75: The dock EC 301 determines whether the battery B2 maintains 90% or more of capacity for 20 days or not. If the determination is NO, the process proceeds to step S71, and if YES, the process proceeds to step S73.
Step S73: The corresponding EC notifies the user of the determination of YES via the CPU 101.
Step S76: The corresponding EC transfers to an ECO charging mode.
Step S77: When the AC adaptor is connected, the CPU 101 automatically uses the battery (uses the battery which maintains 90% or more of capacity for 20 days) until 80% of capacity is reached, via the corresponding EC. When both the tablet and dock batteries correspond to the condition, however, the tablet battery (battery B1) is used until 80% of capacity is reached, and thereafter the dock battery (battery B2) is used.

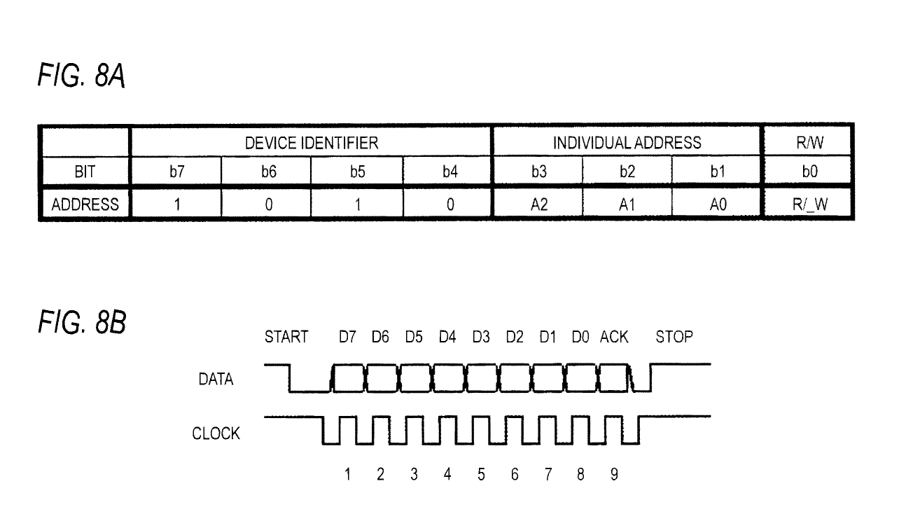

FIGS. 8A and 8B are views illustrating the above-described IIC interface. The bus (IIC-BUS) of the IIC interface is configured by two communication lines respectively for a pull-up clock signal which is output from a master device, and data which are bi-directionally communicated between the master device and a slave device.

FIG. 8A shows an example of the configuration of a slave address. The slave address has a bit length of 8 bits. The most significant 4 bits are fixedly determined in accordance with the kind of the device. When the least 1 bit is 0, it indicates writing, and when the least 1 bit is 1, it indicates reading. In the slave address, therefore, actually usable bits are from bits 1 to 3.

FIG. 8B is a timing schematic diagram of the two lines. As shown in the upper side, when the level value of the signal of the data line becomes Low, Start is performed, and data are sequentially transmitted by starting from the most significant bit, and when the level value of the signal of the data line becomes High, the Stop state is set. The lower side shows the timing of the corresponding clock signal line. FIG. 8B shows an example of the one byte transfer. When transfers of data and ACK are repeated plural times until the Stop state is reached, however, the initial byte is the slave address, but the remaining bytes can contain the communication contents.

In the remaining bytes, the EC/KBC 301 acquires numerical data indicating how many percent of the battery capacity remains, from the Gas Gauge IC in the battery B2. Also the EC/KBC 110 acquires numerical data indicating how many percent of the battery capacity remains, from the Gas Gauge IC in the battery B1.

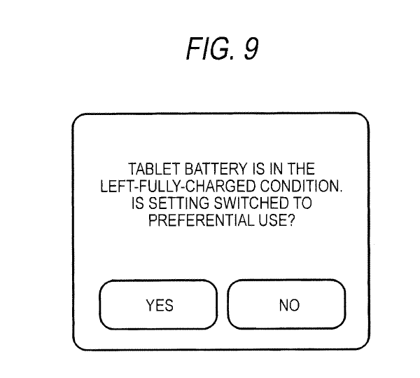

FIG. 9 is a view showing an example of a pop-up display on the LCD 11A in the embodiment. A message “Tablet battery is in the left-fully-charged condition. Is setting switched to preferential use?” is displayed. When the user selects a button of “Yes”, the switching is performed, and when a button of “No” is selected, the current power supply is maintained.

In this configuration, the ECs communicate with the respective ICs in the batteries, and recognize for example “90% or more of battery capacity is maintained for 20 days or longer” as the “left-fully-charged condition”. When this condition is recognized, the user is prompted to transfer the setting to that of ECO charging in which the battery life is prevented from being shortened, by using the pop-up display or the like.

In this case, even when the AC adaptor remains to be connected, a battery in the left-fully-charged condition may be used until a certain threshold (for example, 80%) is reached, with consent of the user. As required, a menu indicating a power supply from the external power source may be configured.

In another embodiment, although, in FIG. 5, the battery selector is used for setting priorities of discharges, this may be realized also by disposing a boosting circuit in one or both of the battery outputs, performing boosting of the output of the battery of preferential discharging, and inputting them in an OR circuit. The outputs are coupled to each other, and one of the two output voltages which is higher is selected to be used in the power supply.

In a modification example, the dock EC in the block diagram may be omitted, and the tablet EC may communicate directly with the dock charger and the dock battery.

In the above embodiment in which a battery particularly in a two-in-one apparatus is controlled so as to be prevented from deteriorating, in an apparatus having plural batteries, it is possible to prevent the life of a battery in which there is a possibility of a low usage frequency, from being shortened by being brought into the left-fully-charged condition.

### (Supplement of Points)

(A). The EC communicates with a battery. In the case where, in the battery, a given or larger remaining amount is continued for a predetermined period or longer, the user is prompted to set ECO charging, by a pop-up display. In this case, even when the AC adaptor remains to be connected, the battery is used until a certain threshold (for example, 80%) is reached, with consent of the user. After setting of ECO charging, the threshold to stop charging, that is, the imaginarily-set full charge capacity is lowered to the certain threshold (80%).

(B) In the case where the EC recognizes that a battery is in the left-fully-charged condition, the battery is preferentially used until a certain threshold is reached. (This may be executed irrespective of whether the user agreed or not.)

(C) In the case of (B), when plural batteries exist in which the remaining amount is larger than the setting of ECO charging, “non-preferential use battery” having a higher possibility of being brought into the left-fully-charged condition is, preferentially used.

The invention is not limited to the embodiment, and may be further implemented by modifying in various manners without departing from the spirit of the invention.

Moreover, plural components disclosed in the above-described embodiment may be appropriately combined with each other, whereby various inventions may be formed. For example, some components may be omitted from the whole components indicated in the embodiment, and moreover components of different embodiments may be adequately combined with each other.

1. An electronic apparatus, comprising:
a component configured to receive a power supply as a load;
a first battery driver configured to manage charging and discharging of a first battery and cause the first battery to perform the power supply to the load;
a second battery driver configured to manage charging and discharging of a second battery and cause the second battery to perform the power supply to the load; and
a controller configured to, upon detection of elapse of a predetermined period from when the first battery is brought into a fully-charged condition, prohibit the power supply to the load from the second battery or a power supply to the load from an external power source, and permit the power supply to the load from the first battery, until a remaining amount of the first battery falls below a predetermined value.

2. The electronic apparatus of claim 1,
wherein the first battery is provided in the electronic apparatus, and
wherein the second battery is provided in a unit which is different from the electronic apparatus.

3. The electronic apparatus of claim 2, further comprising:
a third battery driver configured to manage charging and discharging of a third battery which is provided in the electronic apparatus and cause the third battery to perform the power supply to the load,
wherein the controller is further configured to, when the third battery is close to the fully-charged condition more than the first battery, perform preferentially switching from the power supply from the first battery to the load to the power supply from the third battery to the load.

4. The electronic apparatus of claim 1,
wherein the controller is configured to present an indication to a user as to a selection of the power supply, and based on the selection, start the power supply from one of the plural batteries or the external power source.

5. The electronic apparatus of claim 1,
wherein the controller is further configured to, upon detection of elapse of the predetermined period from when the first battery is brought into the fully-charged condition, lower a threshold to stop charging for the first battery to the predetermined level.

6. The electronic apparatus of claim 1,
wherein the controller is further configured to allow a user to perform setting of preferential use of one of the first battery and the second battery, and
wherein, even if preferential use of the second battery is set, the controller perform prohibition of the power supply from the second battery or the external power source and permission of the power supply from the first battery upon detection of elapse of the predetermined period from when the first battery is brought into the fully-charged condition.
